(19) United States
(12) Patent Application Publication
(10) Pub. No.: US 2010/0080681 A1
(43) Pub. Date: Apr. 1, 2010

(54) METHOD OF ALIGNMENT AND TARGET INDICATOR

(76) Inventor: Roger Ernest Bain, Christchurch (NZ)

Correspondence Address: GREER, BURNS & CRAIN, 300 S WACKER DR, 25TH FLOOR, CHICAGO, IL, 60606, US

(21) Appl. No.: 12/520,447

(22) PCT Filed: Dec. 20, 2007
(86) PCT No.: PCT/NZ2007/000384

§ 371 Date: Nov. 30, 2009

(30) Foreign Application Priority Data
Dec. 20, 2006 (NZ) 548757
Dec. 20, 2006 (NZ) 550994
Jan. 26, 2007 (NZ) 552883

(51) Int. Cl. B60P 1/64; G01D 21/00

(52) U.S. Cl. 414/800; 410/82; 116/209; 116/201

(57) ABSTRACT

A target indicator for visual guidance of a container into secured engagement with a support surface by mating of at least one coupling. The coupling includes a support coupling fitting located on the support surface and a container coupling fitting located on the container. The target indicator includes an attachment at least partially formed with a high visibility exterior and configured to at least partially encircle a coupling fitting in use.

### STATEMENT OF CORRESPONDING APPLICATIONS

This application is based on the Provisional specifications filed in relation to New Zealand Patent Application Numbers 548757, 550994, 552883, the entire contents of each of which are incorporated herein by reference.

### TECHNICAL FIELD

The present invention relates to a method of aligning objects and a target indicator for assisting a user in locating a part of a said object.

In particular, the present invention relates to a method of aligning containers, and particularly shipping containers, with trailers, ship decks, or other support surfaces onto which the container is to be accurately placed in position.

The present invention also relates to a target indicator for assisting a user in coupling such containers to the support surface(s).

### BACKGROUND ART

To aid clarity and avoid prolixity, the present invention will herein be described with respect to aligning and coupling shipping containers to twist-locks or other support coupling fittings positioned to engage with corresponding apertures, locks, fittings, or other container coupling fittings on the base of the container. By way of example, the support coupling fittings may be positioned on a trailer, ship-deck or other support surface on which the container is to be supported.

However, reference herein to such alignment and coupling of shipping containers should not be seen to be limiting as it will be appreciated that the present invention may find other applications involving accurate alignment of other objects with one another.

In many industries, modular steel shipping containers have become a common means for transporting and storing various goods and materials. These containers are typically mounted on trucks, trailers, railway wagons, and freighters for transport. Common multi-purpose shipping containers are standardised 20′ and 40′ ISO (International Standards Organization) containers. These containers are secured during transport by four ISO corner castings at the corners of the base of the container which are engaged by four standard ISO twist locks.

The containers typically also have further apertures in the corners of the roof for receiving locks that can be inter-engaged with another container stacked on top of the roof.

When lifted into place by a crane or the like, the corner castings of the container must be aligned with the twist-locks before being lowered to prevent the locks from being damaged by impact from the container. Over a long period of use, these twist-locks may begin to wear from successive impacts and may require replacing.

Incorrect placement of the container may not only damage the twist-locks but also the support surface or other apparatus on the support surface, e.g. side lifter cranes on a trailer.

Typically the containers are lifted into position on the support surface using a loader such as a straddle crane, top-lifter, ‘top-picks’, reach stacker, Rubber Tyred Gantry crane (RTG), Rail Mounted Gantry crane (RMG) or other gantry crane. It is often difficult for the loader operator to see the twist-locks to align the container. For example, the loader-operator's cab may be up to ten metres above the trailer, and the view through the cab windscreen may be obscured by rain, dirt, and/or low light levels.

Moreover, these difficulties may be exacerbated where the twist-locks are of the same or similar colour to the support surface. It may be particularly difficult to discern the twist-lock fitting from the support surface in marine applications (e.g. ports) where corrosion and sea-salt discolour many surfaces. The visibility of the twist-locks May be enhanced by painting them a bright colour although typical working environments quickly strip or discolour such paint.

It would thus be advantageous to provide a method of alignment that reduces the likelihood of damaging contact between two objects, such as a shipping container and support surface as a result of misalignment.

It would also be advantageous to provide a target indicator capable of assisting a loader operator in visually locating a securing mechanism or the like when aligning the shipping container with the support surface.

Moreover, it would be advantageous if such a target indicator and/or method could be utilised without modifying the container or support surface.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein; this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

According to a first aspect of the present invention there is provided a target indicator for visual guidance of a container into secured engagement with a support surface by mating of at least one coupling, the, or each coupling including a support coupling fitting located on the support surface and a container coupling fitting located on the container, wherein said target indicator includes an attachment at least partially formed with a high visibility exterior, said attachment configured to at least partially encircle a said coupling fitting in use.

The present invention may thus provide a high visibility indicator for a ‘target’ provided in the form of the coupling fitting to which the target indicator is to be attached. The high visibility of the target indicator allows an operator to visually locate at least one said coupling fitting and thereby guide the container onto the support surface such that the coupling fittings mate together.

As used herein, the term “container” refers to any means or apparatus capable of supporting objects for storage or transportation, whether enclosed or not.

Preferably the container is a shipping container.

In a further embodiment the target indicator includes at least one elongate indicator portion extending from the attachment and configured such that when the indicator is attached to the said coupling fitting, the, or each, indicator portion is aligned with a predetermined portion of the coupling fitting to thereby provide an indication of the location of said coupling fitting.

As used herein, the term “support surface” refers to any surface, member or apparatus capable of supporting a container and includes another container. It should be appreciated that reference to a “support surface” should not be seen to be limited to a planar surface.

Reference herein to “high visibility” refers to any visual property that enhances the visibility of the target indicator (or part thereof) and may, by way of example include:
coloration in specific visible colours, e.g. red, green, blue, black, white;
visually contrasting portions, e.g. patterns of different colours or light-reflecting properties;
fluorescent, luminescent, reflective, or incandescent portions;
textured surfaces, e.g. polished, prismatic, pyramidal reflective surfaces or the like;
construction or coating with materials that reflect infra-red or Ultra-Violet (UV) light. It will be appreciated that infra-red or UV light-reflecting properties may require illumination with UV or Infra-red light to ensure the indicator is visible;
any combination of the above.

Preferably the high visibility attachment exterior visually contrasts with the coupling fitting to which it is to be attached

To aid clarity, reference herein will be made to the attachment being configured to attach to the support coupling fitting, although this should not be seen to be limiting as the attachment may be configured to attach to the container coupling fitting.

In typical applications twist-locks are generally of the same appearance as the support surface to which they are fitted. This similar appearance makes it difficult for an operator to discern the protruding twist-lock from its surroundings to thereby align the container. Misalignment when lowering the container onto the twist-lock may result in damaging impact between the container and twist-lock or require the container to be lifted and re-aligned.

Thus, in preferred embodiments the attachment is highly visible with respect to the coupling fitting to which it is to be attached and configured to at least partially encircle said coupling fitting to thereby visibly demarcate said coupling fitting from the support surface and/or container.

It will be appreciated that the target indicator may be formed from a high visibility material (e.g. coloured plastic) or painted or have high visibility material attached, adhered or fixed to the target indicator in some way.

For example, in one embodiment a reflective piece of material may be releasably attached to the attachment and/or indicator portion(s). Thus, if the reflective piece becomes worn, dirty or loses reflectivity, it may be easily replaced without having to replace the entire indicator portion.

It will be appreciated that an infra-red or UV light-reflecting indicator may be particularly useful in military or other operations where containers are to be mounted secretly without use of visible light. For example, the crane operators may utilise infra-red goggles or the like and the operation area may be illuminated with red light or infra-red radiation which is reflected from the target indicator.

Preferably, the target indicator includes at least one portion with a visually contrasting appearance to at least one other portion of the target indicator. Thus, even if the container itself has a high visibility appearance, e.g. painted bright yellow, the location of the target indicator (and, consequently, the coupling fitting) will also still be visible, even if portions of the target indicator are also coloured bright yellow.

Preferably the indicator portion is at least partially formed with a high visibility exterior and more preferably visually contrasts with the attachment such that an operator can distinguish between the attachment and indicator portion.

It will also be appreciated that reference herein to the horizontal alignment of a container with a support surface underneath has been made to aid clarity and should not be seen to be limiting as the present invention may be utilised in alignment of any two objects, horizontally and/or vertically.

Preferably the container coupling fittings are apertures adapted to engage with support coupling fittings provided in the form of twist-locks and the target indicator attachment is configured to attach to a said twist-lock.

Preferably the container is a standard ISO shipping container and the twist-locks of the support are four standard ISO twist locks configured to engage with the corner casting apertures of the shipping container. It will be appreciated that such twist-locks typically include a twist-portion rotateably attached to a base formed on a mounting that is mounted to the support.

Preferably the indicator portion is constructed from a flexible material and more preferably a resilient material such that it may be bent or otherwise flexed substantially orthogonally without breaking.

Preferably the target indicator is constructed from inexpensive material (with respect to the operation involved) such that replacement of the indicator is not prohibitive.

For example, in one preferred embodiment the target indicator is constructed from plastic or other inexpensive durable material.

In some applications, e.g. when loading ships, it may be desirable to provide disposable target indicators. Thus, in an alternative embodiment, the target indicator may be constructed from cardboard, recycled cardboard, or a composite material of cardboard, plastic and/or other recyclable material.

Preferably the attachment includes an aperture sized to receive a said coupling fitting such that the attachment may substantially encircle same. Providing such an encircling attachment may thus serve two purposes, namely to:
ensure a secure attachment that cannot be detached through lateral movement with respect to the coupling fitting, and
visibly demarcate the coupling fitting from its surroundings.

Preferably the attachment is shaped and sized such that it does not substantially obstruct operation of the coupling. For example, the attachment may include a relatively thin planar portion (with respect to a typical twist-lock) with an aperture through which the twist-lock may be passed.

Preferably the aperture is square, rectangular or otherwise shaped to match the support coupling fitting to which it is to be attached. More preferably, the aperture is rectangular to match the base of a typical twist-lock.

Preferably the attachment includes at least one straight edge and more preferably is square or rectangular to provide straight edges. Such straight edges assist in alignment by providing clearly defined lines. A square or rectangular attachment may also minimise wastage during manufacture, e.g. manufacture of circular attachments may result in wasted off-cuts.

Preferably the attachment includes one or more protrusions extending into the aperture to assist in preventing rotation or other movement of the indicator with respect to the attached coupling fitting.

Preferably a said indicator portion is substantially elongate and extends from one side of the attachment perimeter at a proximal end to a distal free end such that when attached, the line between the indicator portion ends aligns with the center of the attached coupling fitting.

Preferably the indicator portion is substantially straight between said ends, although alternative shapes are possible.

In one preferred embodiment, the target indicator may include an identification means integrated or affixed to the indicator portion and/or attachment. For example, a barcode, RFID, magnetic strip, or other readable identification means may be integrated into the indicator portion to thereby allow a user to identify particular target indicators. Identification of target indicators allows a user to match target indicators to containers and/or support surfaces.

It will be appreciated that in some applications the crane or other lifting device for manoeuvring the container may be located to the side or at one end of the container and therefore an indicator portion extending to the side may not be visible from the end and vice versa. Thus, in one embodiment of the present invention, two such indicator portions may be provided, one extending from a first side of the attachment and the other from a perpendicular second side, thus providing two lines of reference to assist in alignment.

Where two indicator portions are provided on an indicator with a rectangular attachment aperture it will be appreciated that one indicator portion will be obscured underneath the container when the attachment is rotated by 90° to fit a coupling on the opposing side of the support. To alleviate this problem in a further preferred embodiment the indicator portions may have high visibility portions on both sides, (upper and lower in use) such that the indicator may be turned over to fit onto an opposing coupling while still being visible and ensuring one indicator portion extends away from the support to the side and one extends away from the end.

It will be appreciated that the free-end may protrude from the support coupling fitting and therefore be vulnerable to damage from objects moving past. To reduce the likelihood of such damage the free end is preferably shaped to be retained by a restraint provided on the support surface or container to prevent the free end from protruding when not in use.

For example, the free end may be substantially ‘T’-shaped. The indicator portion may then be flexed such that the crossbar of the ‘T’ is releasably restrained in an aperture, loop, lasso, or other restraint on the container, support or part thereof.

Preferably a recess is provided in the free end to assist a user in gripping the free end for release from the restraint.

According to a second aspect of the present invention there is provided a method of guiding a container into secured engagement with a support surface by mating of at least one coupling, the, or each coupling including a support coupling fitting located on the support surface and a container coupling fitting located on the container, said method including the steps of:
having a target indicator attached to at least one said coupling fitting;
manoeuvring the container towards said support surface such that a predetermined portion of the, or each, target indicator is aligned with a predetermined portion of an opposing coupling fitting; and
moving the container onto the support surface such that said coupling fittings are secured into mating engagement.

Preferably the, or each, target indicator used in the aforementioned method is substantially as hereinbefore described.

Thus, the present invention may provide a target indicator capable of visibly demarcating a coupling fitting from its surroundings to thereby assist a user in aligning a corresponding opposing coupling fitting for subsequent mating engagement.

The present invention may also provide a method of aligning coupling fittings on a support and container that reduces the likelihood of misalignment of the coupling.

### BRIEF DESCRIPTION OF DRAWINGS

Further aspects and advantages of the present invention will become apparent from the following description which is given by way of example only and with reference to the accompanying drawings in which:

FIG. 1 shows a target indicator according to one preferred embodiment of the present invention;

FIG. 2a shows a plan view of an exemplary trailer for supporting and transporting a shipping container;

FIG. 2b shows a plan view of the trailer of FIG. 1 with target indicators attached according to one preferred embodiment of the present invention;

FIG. 3a shows a plan view of an exemplary twist-lock;

FIG. 3b shows a plan view of the twist-lock of FIG. 3a with a target indicator attached according to one preferred embodiment;

FIG. 4 shows a plan view of a target indicator according to a second preferred embodiment;

FIG. 5 shows a side elevation of the target indicator of FIG. 3 in use;

FIG. 6 shows a vertical cross-section of a container, trailer and the target indicator of FIG. 4 in use as shown in FIG. 5;

FIG. 7 shows a plan view of a third preferred embodiment of the present invention.

### BEST MODES FOR CARRYING OUT THE INVENTION

It should be appreciated that the following description is made by way of example only and should not be seen to be limiting.

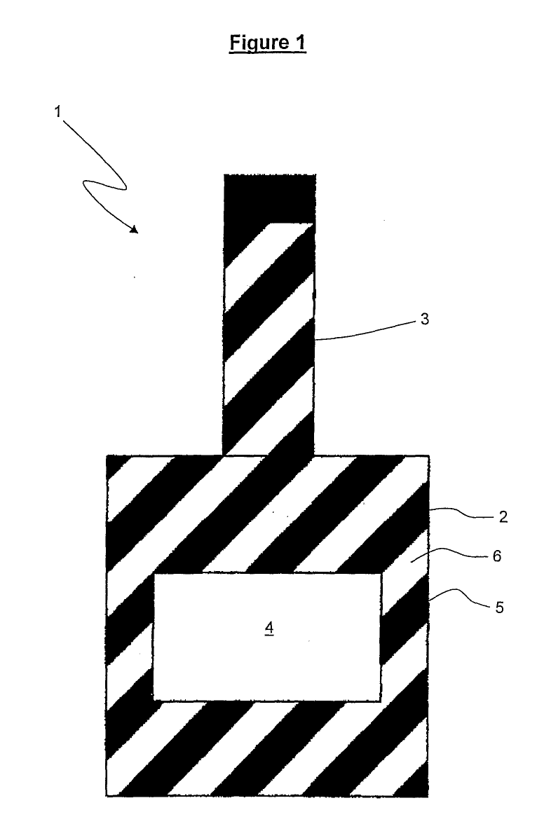

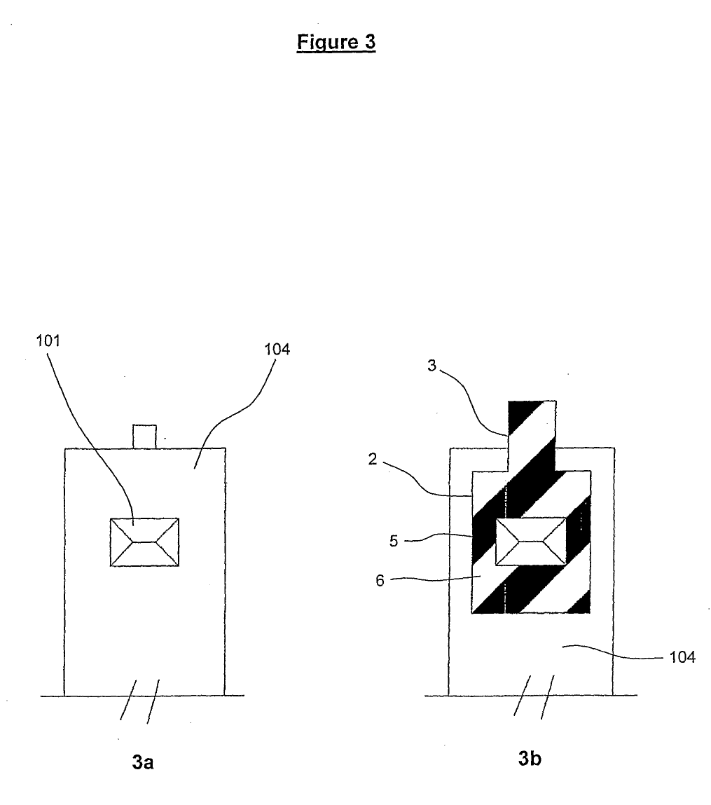

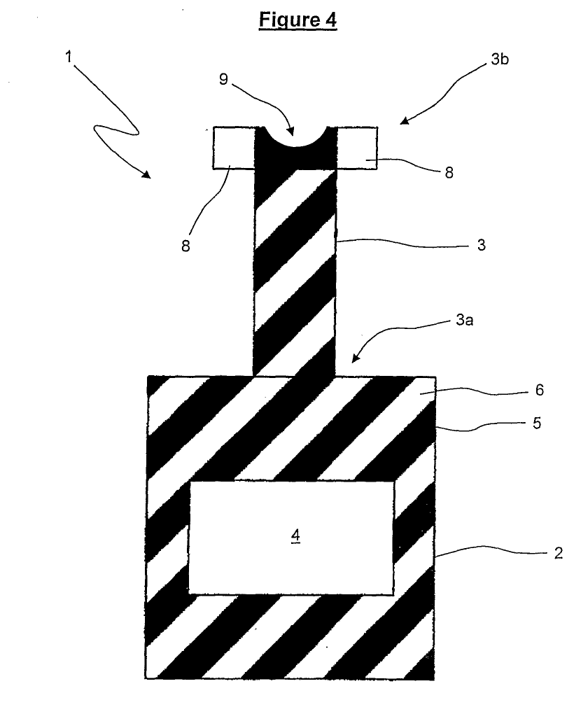

With respect to FIGS. 1-3 there is provided a target indicator (1) for assisting in guidance of a standard ISO shipping container (200) into engagement with a support surface provided in the form of trailer (100).

The container (200) is engaged with the trailer (100) by mating of four couplings, the couplings each have a support coupling fitting and container coupling fitting.

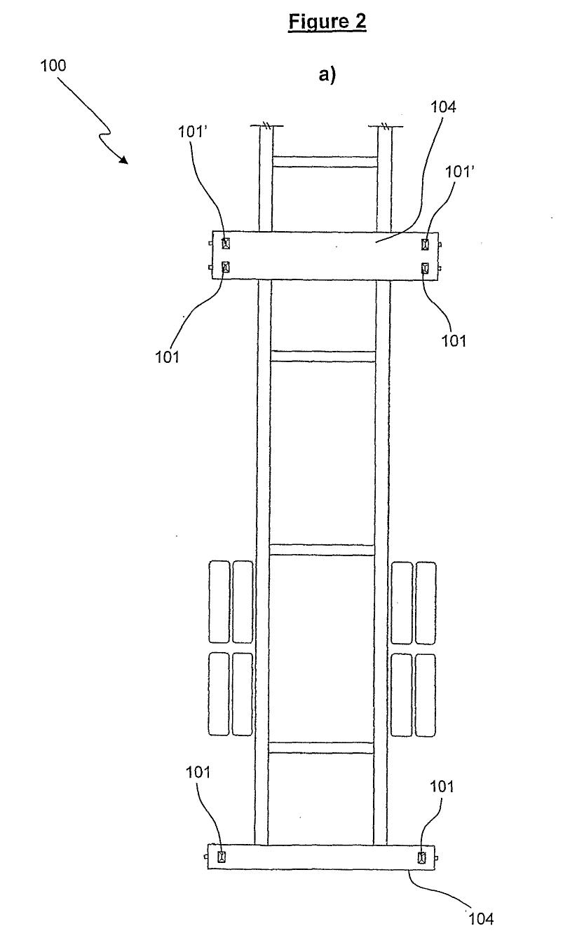

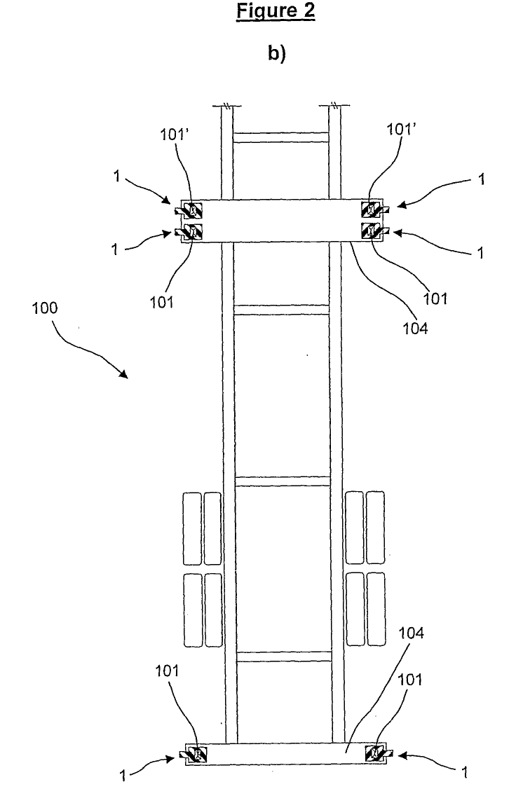

The support coupling fitting is provided in the form of a standard ISO twist-lock (101) (as shown in FIGS. 2-3 and 6) located on the trailer (101).

The container coupling fitting is provided in the form of apertures (201) formed in the corner castings (202) of the container (200).

The target indicator (1) has an attachment (2) for attaching the indicator (1) to a twist-lock (101).

The target indicator (1) also has an elongate handle and indicator portion (3) extending from one side of the attachment (2) to assist in attaching and detaching of the indicator (1) to the twist-lock (101).

The indicator (1) is also configured such that when attached, the indicator portion (3) is substantially straight and aligned in use with the centre of the twist-lock (101) to thereby provide an indication of the location of the twist-lock (101) even when the twist-lock is obscured.

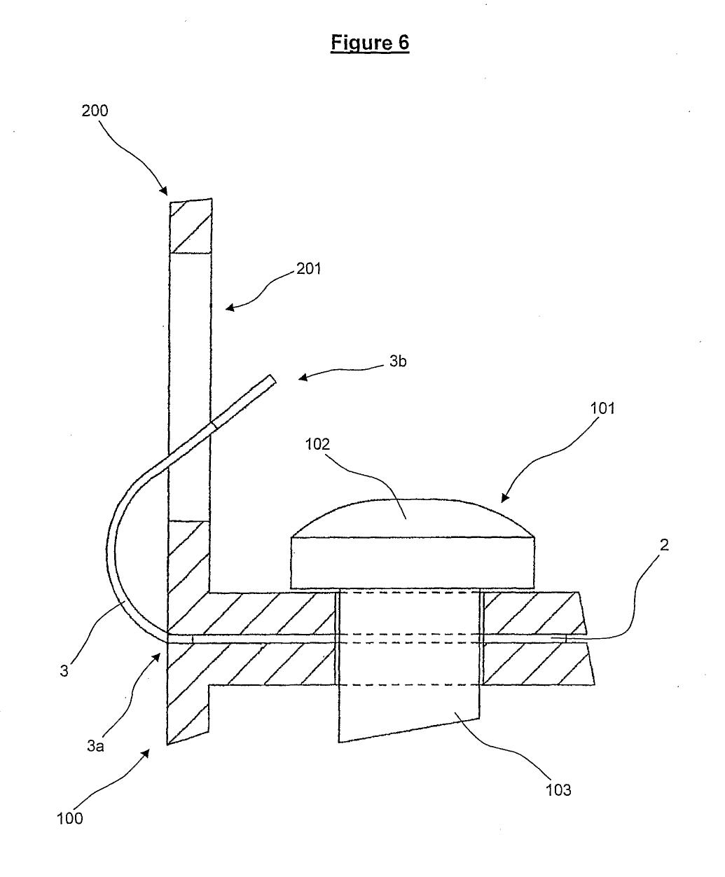

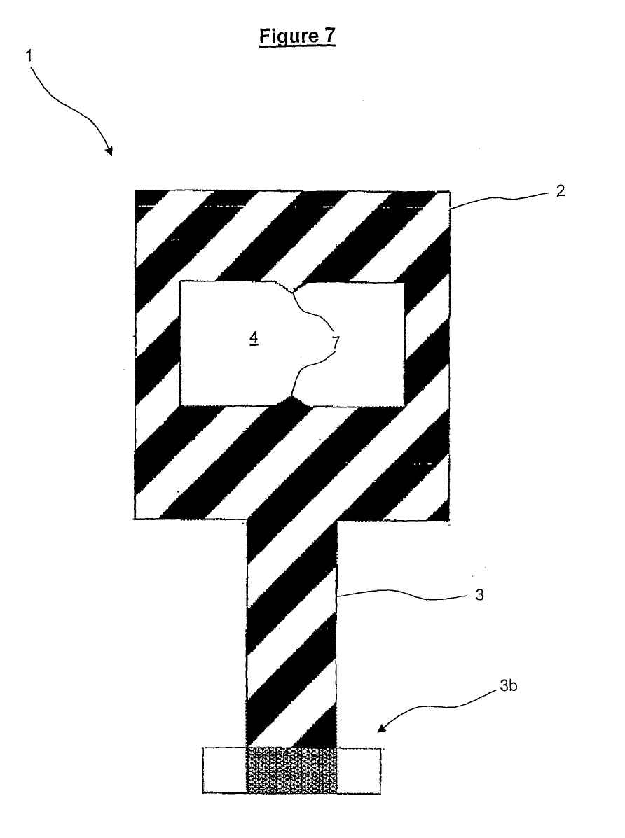

The target indicator (1) is constructed from a flexible plastic material and is relatively thin with respect to the twist-lock (101) such that it does not interfere with the operation of the twist-lock (101). As shown in FIG. 6, each twist-lock (101) has a twist-portion (102) rotateably attached to a base (103) formed on a mounting (104) that is mounted to the trailer (100).

The plastic indicator (1) is resilient such that it may be bent or otherwise flexed without breaking. The indicator (1) is thus sufficiently robust and durable while also being relatively inexpensive.

While many suitable plastics may be used to construct the indicator (1), it has been found that a particularly useful material is an abrasion resistant polyurethane with a Shore hardness of 95 in a high-visibility colour such as yellow, orange or white.

In the preferred embodiments shown in the figures, the indicator (1) has an upper exterior surface with a striped pattern of alternating black (5) and high-visibility (6) reflective strips. These strips (5, 6) are formed separately from the indicator and adhered to the indicator (1) to form the upper surface. As these reflective strips (5, 6) may become worn, dirty or lose reflectivity, they can be removed or replacement strips adhered on top of the worn strips, without having to replace the entire indicator (1).

The attachment (2) includes a rectangular aperture (4) sized and shaped to encircle the twist-lock base (103). Providing such an encircling attachment (2) thus serves two purposes, namely to:
ensure a secure attachment (2) that cannot be detached through lateral movement with respect to the twist-lock (101), and
visibly demarcate the twist-lock (101) from its mounting (104) and the trailer (100).

As the attachment (2) encircles and is highly visible with respect to the twist-lock (101), the twist-lock (101) is visibly demarcated from the mounting (104) and trailer (100).

This visual demarcation can be more readily seen when comparing FIG. 2a with 2b and 3a with 3b in which the encircling attachments (2) demarcate the twist-locks (101) and provide the visual ‘target’.

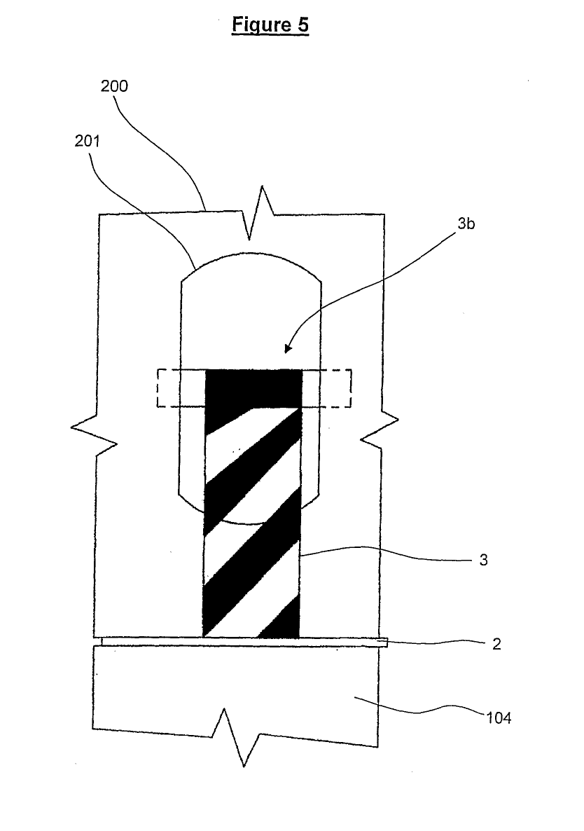

As shown in FIG. 2, the trailer (100) (not fully shown) is configured to carry two shipping containers (200) (partially shown in FIGS. 5 and 6 only) by securing the corner apertures (201) of a first container (not shown) to the first set of four twist-locks (101). The second container (not shown) is attached to another set of four twist-locks (101′) of which only two are shown in FIG. 2.

In use, the container corner apertures (201) are aligned with the twist-locks (101) of the trailer shown in FIG. 2a by performing the following steps:
attaching a target indicator (1) via the encircling attachment (2) to each twist-lock (101), as shown in FIG. 2b;
manoeuvring the container (200) above the trailer (100) such that the corner apertures (201) are aligned with the twist-locks (101); and
lowering the container (200) onto the trailer (100) such that the apertures (201) engage with the twist-locks (101).

Once the container (200) is lowered and the twist-locks locked, the target indicators (1) are trapped between the container (200) and twist-lock mounting (104) and may only be removed for reuse or replacement when the container (200) is lifted from the trailer (100).

It will be appreciated that the free-end (3b) of the indicator portion (3) may protrude to one side of the twist-lock (101) and trailer (100) and therefore be vulnerable to damage from objects moving past or otherwise prove inconvenient for an operator.

A target indicator (1) according to a second preferred embodiment is shown in FIG. 4 and has a ‘T’-shaped free end (3b). The crossbar (8) of the ‘T’ may then be used to releasably restrain the free end (3b) in an aperture (201) on the container (200) as shown in FIG. 6 and thereby prevent the free-end (3b) from protruding to the side of the trailer (100).

It can be difficult for a user to release the free end (3b) from the aperture (201) as the aperture (201) is often too small for users with large hands and thus, a recess (9) is provided in the crossbar (8) to allow a user to insert a finger, rod or the like into the recess (9) to thereby assist in removing the free end (3b) from the aperture (201).

As shown in FIG. 7, a third preferred embodiment of the indicator (1) has an attachment (2) with two protrusions (7) extending into the aperture (4) to assist in preventing rotation or other movement of the indicator (1) with respect to the twist-lock (101).

The protrusions (7) provide a frictional engagement with the twist-lock (101) to help prevent detachment. Such detachment problems may arise from indicators (1) tending to stick to the container (200) and thus being removed with the container (200) when lifted. In a majority of cases, it is likely that this problem can be overcome simply by pulling the indicator (1) off the underside of the container (200). However, if this becomes a problem, it is envisaged that the indicators (1) could be made for single use, or each indicator (1) could be tethered to the trailer (100), e.g. by a lanyard or other restraint secured at one end to the trailer (100) and at the other end to a hole formed in the handle and indicator portion (3).

When the container (200) is removed, each indicator (1) is reversed such that the handle portion (3) projects inward over the trailer (100) and may be secured in position by closing the twist lock (101) to prevent the handle portions (3) from projecting beyond the permissible overall width of the trailer (100).

Aspects of the present invention have been described by way of example only and it should be appreciated that modifications and additions may be made thereto without departing from the scope thereof.

1. A target indicator for visual guidance of a container into secured engagement with a support surface by mating of at least one coupling, the, or each coupling comprising: a support coupling fitting located on the support surface and a container coupling fitting located on the container, wherein said target indicator includes an attachment at least partially formed with a high visibility exterior, said attachment configured to at least partially encircle one of said coupling fittings in use.

2. A target indicator as claimed in claim 1, wherein the target indicator includes at least one elongate indicator portion extending from the attachment and configured such that when the indicator is attached to the said coupling fitting, the, or each, indicator portion is aligned with a predetermined portion of the said coupling fitting to thereby provide an indication of the location of said predetermined portion.

3. A target indicator as claimed in claim 2, wherein the indicator portion is at least partially formed with a high visibility exterior.

4. A target indicator as claimed in claim 1, wherein the target indicator includes at least one portion with a visually contrasting appearance to at least one other portion of the target indicator.

5. A target indicator as claimed in claim 2, wherein the indicator portion visually contrasts with the attachment.

6. A target indicator as claimed in claim 2, wherein the indicator portion is constructed from a flexible material.

7. A target indicator as claimed in claim 6, wherein the indicator portion is constructed from a resilient material.

8. A target indicator as claimed in claim 1, wherein the high visibility attachment exterior visually contrasts with the coupling fitting to which it is to be attached.

9. A target indicator as claimed in claim 1, wherein the high visibility attachment exterior includes two or more visually contrasting portions.

10. A target indicator as claimed in claim 1, wherein the container coupling fitting is an aperture adapted to engage with a support coupling fitting provided in the form of a twist-lock and the target indicator attachment is configured to attach to said twist-lock.

11. A target indicator as claimed in claim 10, wherein the container is a standard ISO shipping container and the twist-locks of the support are four standard ISO twist locks configured to engage with the corner casting apertures of the shipping container.

12. A target indicator as claimed in claim 1, wherein the attachment includes an aperture sized to receive the coupling such that the attachment may encircle same.

13. A target indicator as claimed in claim 12, wherein the aperture is rectilinear.

14. A target indicator as claimed in claim 12, wherein the attachment includes one or more protrusions extending into the aperture.

15. A target indicator as claimed in claim 1, wherein a said indicator portion is substantially elongate and extends from one side of the attachment perimeter at a proximal end, to a distal free end such that when attached to the said coupling fitting, the indicator portion ends align with the center of the said coupling fitting.

16. A target indicator as claimed in claim 15, wherein, two said indicator portions are provided, one extending from a first side of the attachment and the other from a perpendicular second side.

17. A target indicator as claimed in claim 15, wherein said free end is shaped to be retained by a restraint provided on the support or container.

18. A target indicator as claimed in claim 17, wherein the free end is substantially ‘T’-shaped.

19. A target indicator as claimed in claim 17, wherein a recess is provided in the free end.

20. A method of guiding a container into secured engagement with a support surface by mating of at least one coupling, the, or each coupling including a support coupling fitting located on the support surface and a container coupling fitting located on the container, said method including the steps of:
having a target indicator attached to at least one said coupling fitting;
manoeuvring the container toward said support surface such that a predetermined portion of the, or each, target indicator is aligned with a predetermined portion of an opposing coupling fitting; and
moving the container onto the support surface such that said coupling fittings are secured into mating engagement.

21. The method of claim 20, wherein the target indicator is a target indicator for visual guidance of a container into secured engagement with a support surface by mating of at least one coupling, the, or each coupling comprising: a support coupling fitting located on the support surface and a container coupling fitting located on the container, wherein said target indicator includes an attachment at least partially formed with a high visibility exterior, said attachment configured to at least partially encircle said support coupling fitting in use.

22. (canceled)

23. (canceled)
